(19) United States
(12) Patent Application Publication
(10) Pub. No.: US 2021/0388576 A1
(43) Pub. Date: Dec. 16, 2021

(54) TRACTOR BUCKET ADAPTER SYSTEM

(71) Applicant: William Thomas King, Boring, OR (US)

(72) Inventor: William Thomas King, Boring, OR (US)

(21) Appl. No.: 17/344,545

(22) Filed: Jun. 10, 2021

Related U.S. Application Data
(60) Provisional application No. 63/037,266, filed on Jun. 10, 2020.

(51) Int. Cl. E02F 3/96; E02F 5/02; A01G 20/12

(52) U.S. Cl. CPC E02F 3/962; A01G 20/12; E02F 5/025

(57) ABSTRACT

A system can include a tractor bucket adapter configured to be removably attached to a bucket of a tractor, and a component configured to be removably attached to the tractor bucket adapter. The component may be a digging tool or a sod removal tool. The system can also include an intermediary component to facilitate removable attachment between the tractor bucket adapter and the component.

### CROSS-REFERENCE TO RELATED APPLICATIONS

The present application claims priority to U.S. Provisional Application No. 63/037,266, entitled “TRACTOR BUCKET ADAPTER SYSTEM”, and filed on Jun. 10, 2020. The entire contents of the above-listed application are hereby incorporated by reference for all purposes.

### SUMMARY

Disclosed herein are embodiments directed to a tractor bucket adapter system that generally include: a tractor bucket adapter that is configured to be removably attached to the bucket of a tractor; and at least one component that is configured to be removably attached to the tractor bucket adapter. The system may further include an intermediary component configured to facilitate removable attachment between the tractor bucket adapter and the components.

### BRIEF DESCRIPTION OF THE DRAWINGS

FIG. 1 is a first front perspective view of a first embodiment of a tractor bucket adapter for use with interchangeable components.

FIG. 2 is a top side elevation view of the first embodiment of the tractor bucket adapter.

FIG. 3 is a bottom side elevation view of the first embodiment of the tractor bucket

adapter.

FIG. 4 is a front plan view of the first embodiment of the tractor bucket adapter.

FIG. 5 is a side elevation view of the first embodiment of the tractor bucket adapter.

FIG. 6 is a back plan view of the first embodiment of the tractor bucket adapter.

FIG. 7 is a front perspective view of a tractor adaptor system including the first embodiment of the tractor bucket adapter for mounting interchangeable components.

FIG. 8 is a front perspective view of a first component suitable for use with the disclosed tractor bucket adapter.

FIG. 9 is a side elevation view of the first component.

FIG. 10 is a front plan view of the first component.

FIG. 11 is a back plan view of the first component.

FIG. 12 is a top side elevation view of the first component.

FIG. 13 is a bottom side elevation view of the first component.

FIG. 14 is a front perspective view of a second component suitable for use with the disclosed tractor bucket adapter.

FIG. 15 is a side elevation view of the second component.

FIG. 16 is a front plan view of the second component.

FIG. 17 is a back plan view of the second component.

FIG. 18 is a top side elevation view of the second component.

FIG. 19 is a bottom side elevation view of the second component.

FIG. 20 is a front perspective view of a third component suitable for use with the disclosed tractor bucket adapter.

FIG. 21 is a side elevation view of the third component.

FIG. 22 is a front plan view of the third component.

FIG. 23 is a back plan view of the third component.

FIG. 24 is a top side elevation view of the third component.

FIG. 25 is a bottom side elevation view of the third component.

FIG. 26 is a front perspective view of a fourth component suitable for use with the disclosed tractor bucket adapter.

FIG. 27 is a back perspective view of the fourth component.

FIG. 28 is a side elevation view of the fourth component.

FIG. 29 is a front plan view of the fourth component.

FIG. 30 is a back plan view of the fourth component.

FIG. 31 is a top side elevation view of the fourth component.

FIG. 32 is a bottom side elevation view of the fourth component.

FIG. 33 is a side elevation view of an intermediary component configured to facilitate removable attachment between the tractor bucket adapter and the components.

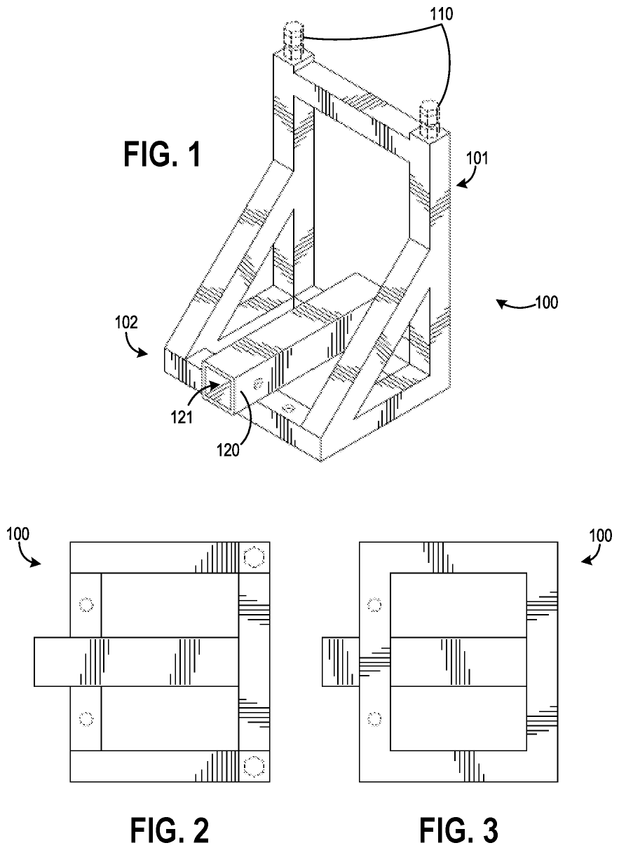

FIGS. 1-33 are drawn approximately to scale. However, other relative component dimensions may be used, in other embodiments.

### DETAILED DESCRIPTION

The following description relates to a tractor bucket adapter configured for coupling interchangeable components (e.g., digging tools, sod removal tools, etc.) to a bucket of a tractor. The interchangeable components may have different purposes to be used for different applications, such as digging operations, sod removal operations, etc. The interchangeable components may also be configured to be easily and removably attached to the tractor bucket adapter. Further, the interchangeable components may be removably attached to the tractor bucket adapter by, in some cases, an intermediary component. In this way, by providing a modular system for easily attaching and removing a variety of components to a tractor bucket, a simple yet reliable system for efficiently and effectively attaching a desired tool component to a tractor bucket for a given application is realized.

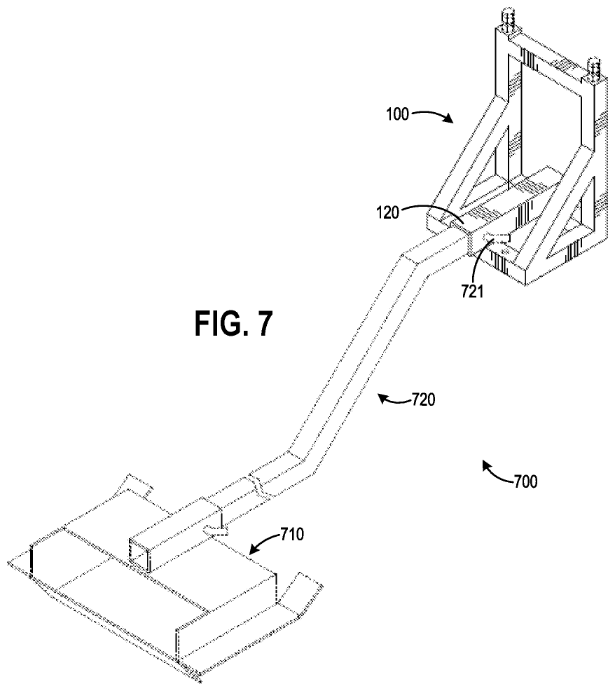

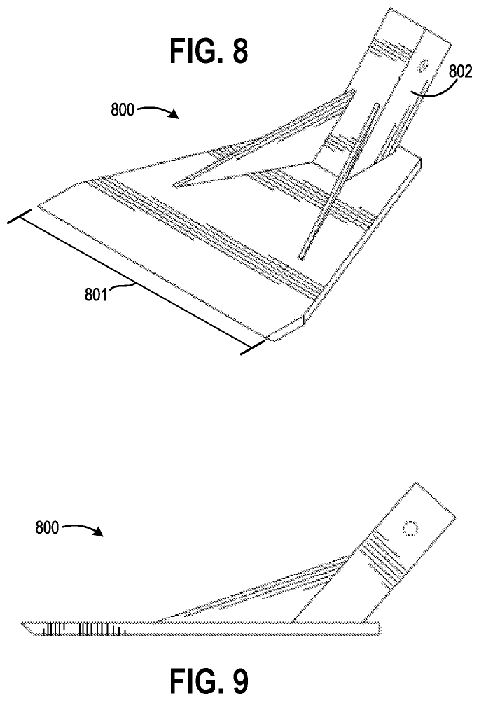

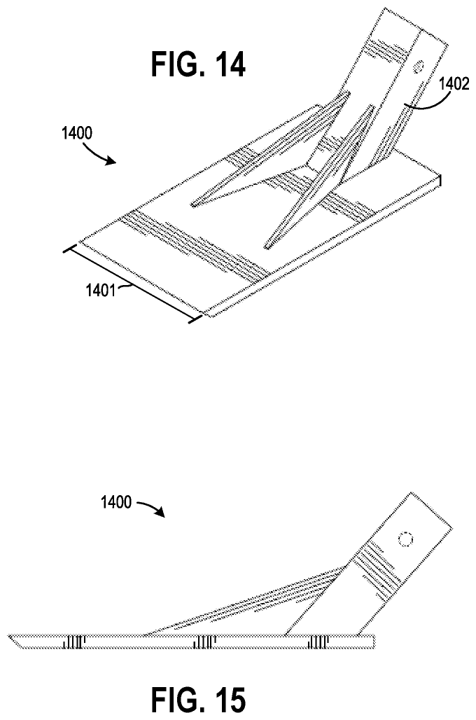

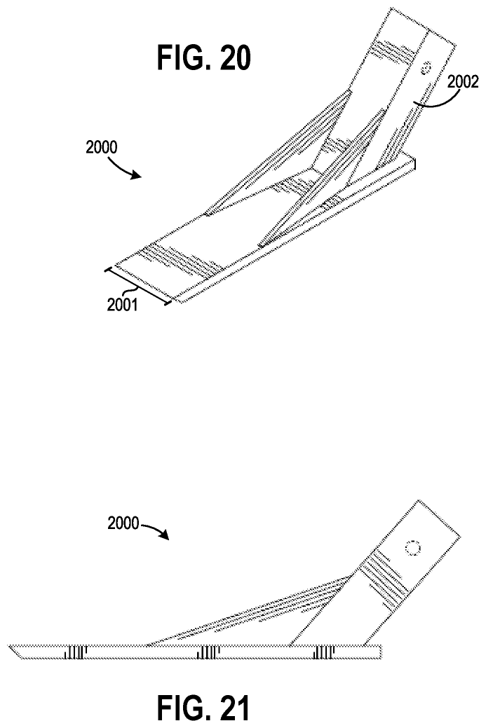

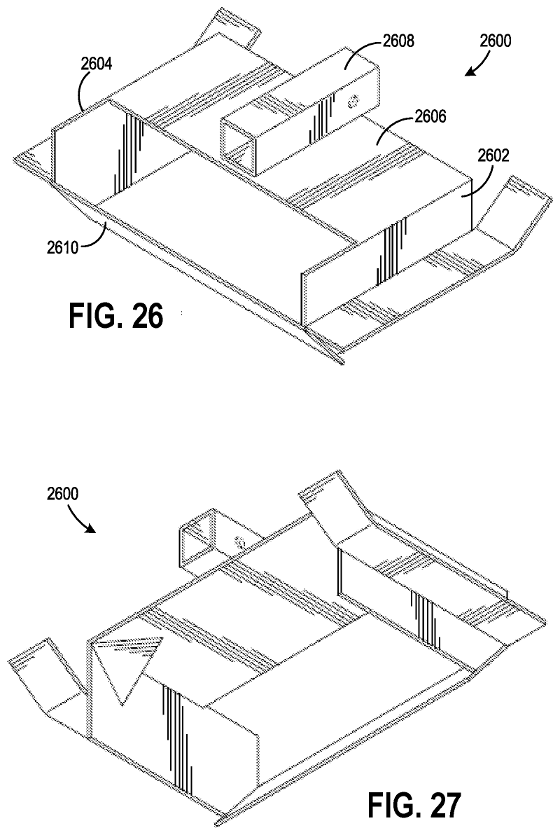

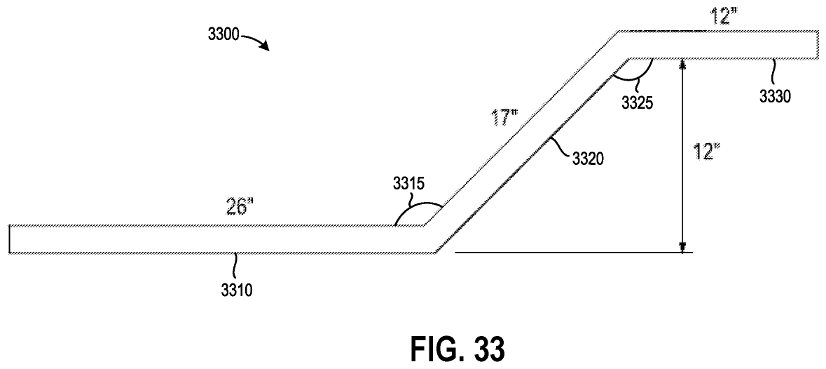

FIGS. 1-7 show a first embodiment of a tractor bucket adapter, with FIG. 7 illustrating the first embodiment of the tractor bucket adaptor implemented with an interchangeable component in a tractor bucket adapter system. FIGS. 8-13 illustrate an example of a first component for attachment to a tractor bucket, while FIGS. 14-19 illustrate a second component, FIGS. 20-25 illustrate a third component, and FIGS. 26-32 illustrate a fourth component, where each of the components may be have a different function and/or purpose. FIG. 33 depicts an example of an intermediary component to facilitate attachment of a component, such as any component shown in FIGS. 1-32, to a tractor bucket adapter, such as the tractor bucket adapter shown in FIGS. 1-7.

FIGS. 1-6 together illustrate a first embodiment of a tractor bucket adapter 100 for use with interchangeable components. In one example, the adapter 100 may be formed from steel or other suitable materials (e.g., metals) or, in some examples, may be formed from a combination of two or more different types of materials. The adapter 100 may have a rear portion 101 and a front portion 102.

At the rear portion 101, the adapter 100 may have a securing mechanism 110 (e.g., nuts, bolts, screws, or other suitable items), as shown in FIG. 1, to secure positioning of the adapter 100 within the bucket of a tractor. For example, a user may place the adapter 100 in a certain desired location and position within a tractor bucket and then make use of the securing mechanism to ensure that the adapter maintains its position and location within the tractor bucket. In some examples, the securing mechanism 110 may include two securing mechanisms positioned proximate the rear portion 101 on an upper side of the adapter 100. However, other configurations of the securing mechanism have been envisioned, in other examples. For instance, the securing mechanism may include a plurality of securing mechanisms positioned along a bottom side of the adapter 100, or may be positioned along opposite sides of the adapter at the rear portion 101.

The adapter 100 may further include a coupling component 120, which may be a hollow or substantially hollow component having an opening 121 at the front portion 102 of the adapter. The coupling component 120 may be configured to receive an intermediary component, within opening 121, to facilitate attachment of an auxiliary component to the adapter 100 and, consequently, to the tractor bucket when the adapter is attached to the tractor bucket via the securing mechanism 110. In some examples, the adapter may include another securing mechanism for securely and removably coupling the intermediary component within coupling component 120, as will be described herein, particularly with reference to FIG. 7.

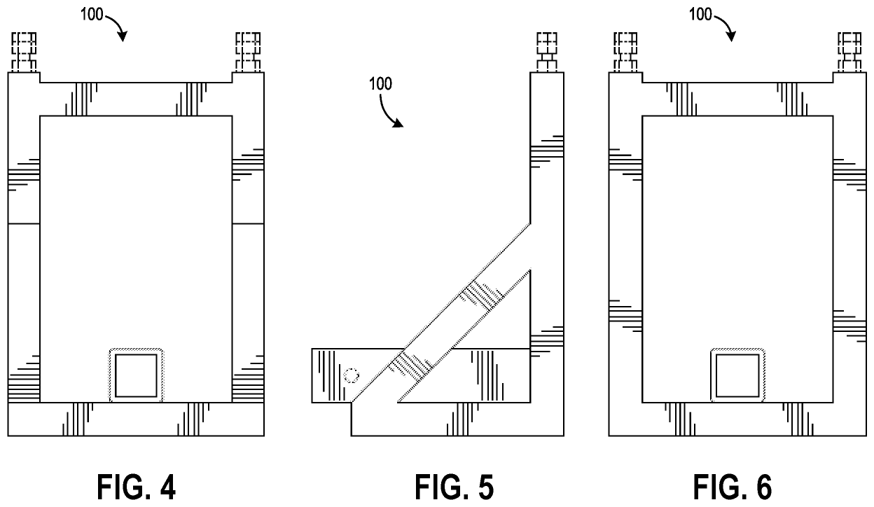

FIGS. 2 and 3 show a top side and a bottom side elevation view of the adapter 100, respectively. FIGS. 4 and 6 show a front and back plan view of the adapter 100, respectively, and FIG. 5 shows a side elevation view of the adapter 100.

FIG. 7 illustrates a tractor bucket adapter system 700, again illustrating the tractor bucket adapter 100 described in FIGS. 1-6. The adapter system 700, in this example, includes an interchangeable component 710 removably attached to the tractor bucket adapter 100 by way of an intermediary component 720. The interchangeable component 710 and the intermediary component 720 may be formed from steel or other suitable materials (e.g., metals) or, in some examples, may be formed from a combination of two or more different types of materials.

The intermediary component 720 may be removably attached to the adapter 100, as described above, by inserting a first end of the intermediary component within the coupling component 120 of the adapter. The adapter 100 may have a pair of holes and the intermediary component 720 may have a corresponding pair of holes, such that the holes are aligned when the intermediary component 720 is received within the coupling component 120 of the adapter 100, and a large cotter pin 721 or other suitable device may be inserted fully through both pairs of holes to achieve a secure coupling between the components. A similar arrangement may be used for securing the interchangeable component 710 to a second end of the intermediary component 720, such that the second end of the intermediary component is received within an opening defined in the interchangeable component 710, and another securing mechanism (e.g., large cotter pin or other suitable device) is inserted through corresponding pairs of holes in the components to facilitate the secure attachment. In this way, the system 700 offers a simple and inexpensive configuration for reliably (and removably) securing the first end and the second end of the intermediary component 720 to the adapter 100 and the component 710, respectively. In other examples, however, other securing devices and mechanisms for removably securing the intermediary component to the tractor bucket adapter and the component have been contemplated, such as, for instance, bolts, screws, and the like.

Another example of an intermediary component, which may be substantially similar or identical to intermediary component 720, is further illustrated in FIG. 33. FIG. 33 shows a side elevation view of an intermediary component 3300 that can be configured to facilitate the removable attachment between the tractor bucket adapter and the at least one component, as described above. In the example, the intermediary component has three portions: a first portion 3310 having a length of 26 inches, a second portion 3320 having a length of 17 inches, and a third portion 3330 having a length of 12 inches. However, in other examples, each of the portions of the intermediary component 3300 may have a different length. An angle 3315 between the first and second portions of the component 3300 may be 45 degrees or, in other examples, another suitable angle, and an angle 3325 between the second and third portions of the component may be 45 degrees or, in other examples, another suitable angle.

It will be appreciated that the number and types of components that may be used in connection with the tractor bucket adapter is virtually limitless. It will be further appreciated that the types of securing mechanisms in connection with the intermediary component are also virtually limitless.

FIGS. 8-13 together illustrate a first component 800 suitable for use with the disclosed tractor bucket adapter. In the example, the component is a digging tool that has a width 801 of approximately 12 inches, as indicated in the front perspective view shown in FIG. 8, and has a generally tapered geometry, though it will be appreciated that the digging tool can have virtually any suitable width, length, height, and geometry. The component 800 may further include a coupling portion 802 configured for facilitating removable attachment of the component 800 to an intermediary component, as previously described. In some examples, the digging tool may be used for digging a trench for installing a sprinkler system in a lawn or planting seeds, for example. The digging tool may be used to dig such a trench as deep as, or even deeper than, 18 inches, for example.

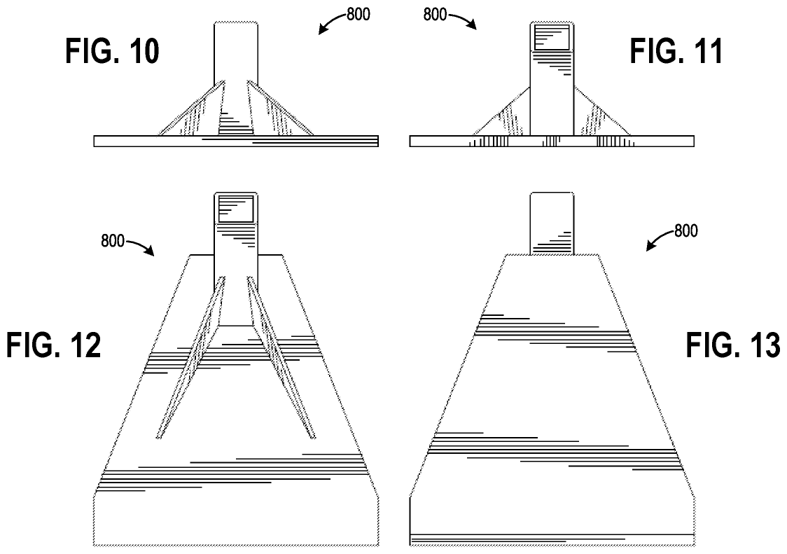

FIG. 9 shows a side elevation view of the first component 800. FIGS. 10 and 11 show a front and back plan view of the adapter 100, respectively, and FIGS. 12 and 13 show a top side and a bottom side elevation view of the adapter 100, respectively.

FIGS. 14-19 together illustrate a second component 1400 suitable for use with the disclosed tractor bucket adapter. In the example, the component is a digging tool that has a width 1401 of approximately 8 inches, as indicated in the front perspective view of the component 1400 shown in FIG. 14, though it will be appreciated that the digging tool can have virtually any suitable width, length, height, and geometry. The component 1400 may further include a coupling portion 1402 configured for facilitating removable attachment of the component 1400 to an intermediary component, as previously described. The digging tool may be used for digging a trench for installing a sprinkler system in a lawn or planting seeds, for example. The digging tool may be used to dig such a trench as deep as, even deeper than, 18 inches, for example.

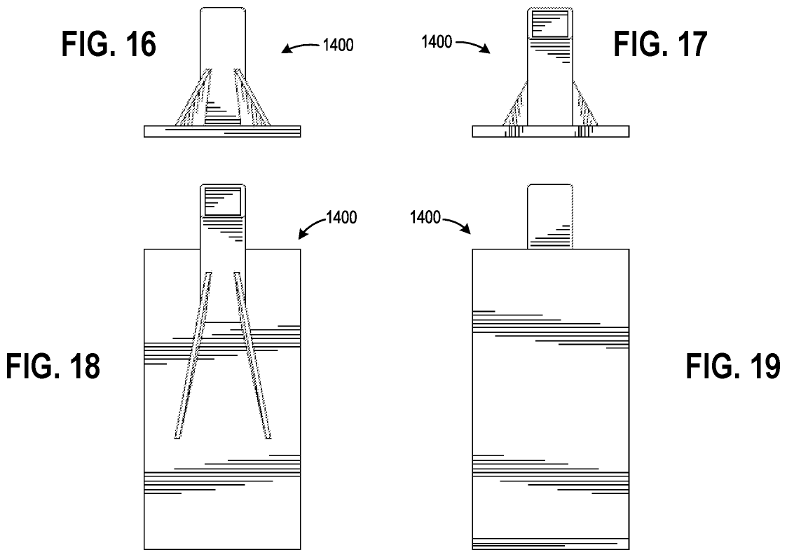

FIG. 15 shows a side elevation view of the second component 1400. FIGS. 16 and 17 show a front and back plan views of the component 1400, respectively, and FIGS. 18 and 19 show a top side and a bottom side view of the component 1400, respectively.

FIGS. 20-25 together illustrate a third component 2000 suitable for use with the disclosed tractor bucket adapter. In the example, the component is a digging tool that has a width 2001 of approximately 4 inches, as indicated in the front perspective view of the component 2000 shown in FIG. 20, though it will be appreciated that the digging tool can have virtually any suitable width, length, height, and geometry. The component 2000 may further include a coupling portion 2002 configured for facilitating removable attachment of the component 2000 to an intermediary component, as previously described. The digging tool may be used for digging a trench for installing a sprinkler system in a lawn or planting seeds, for example. The digging tool may be used to dig such a trench as deep as, or even deeper than, 18 inches, for example.

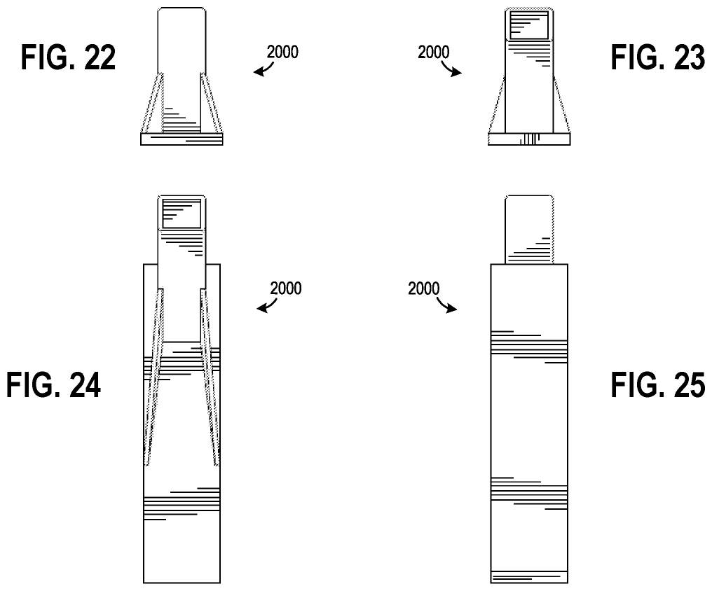

FIG. 21 shows a side elevation view of the third component 2000. FIGS. 22 and 23 show a front and back plan view of the component 2000, respectively, and FIGS. 24 and 25 show a top side and a bottom side elevation view of the component 2000.

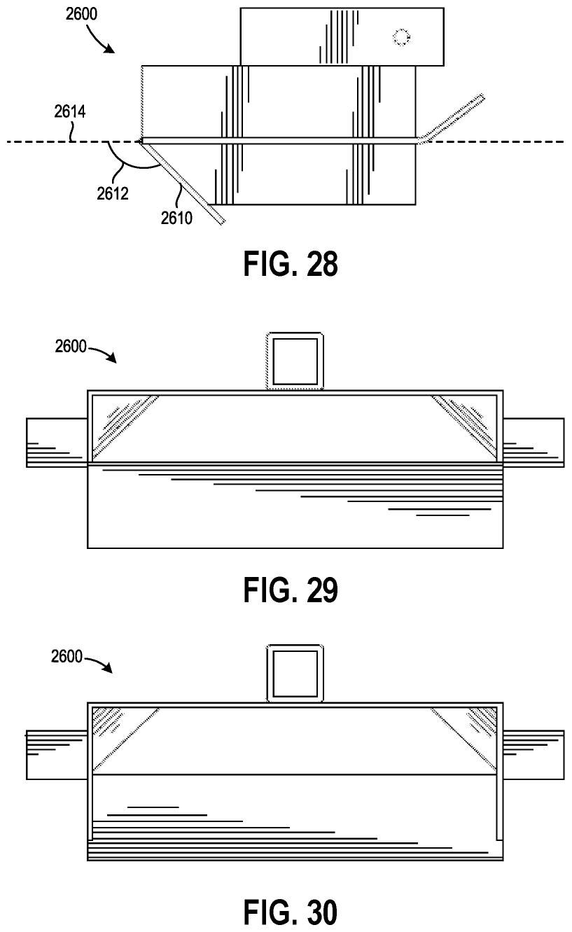

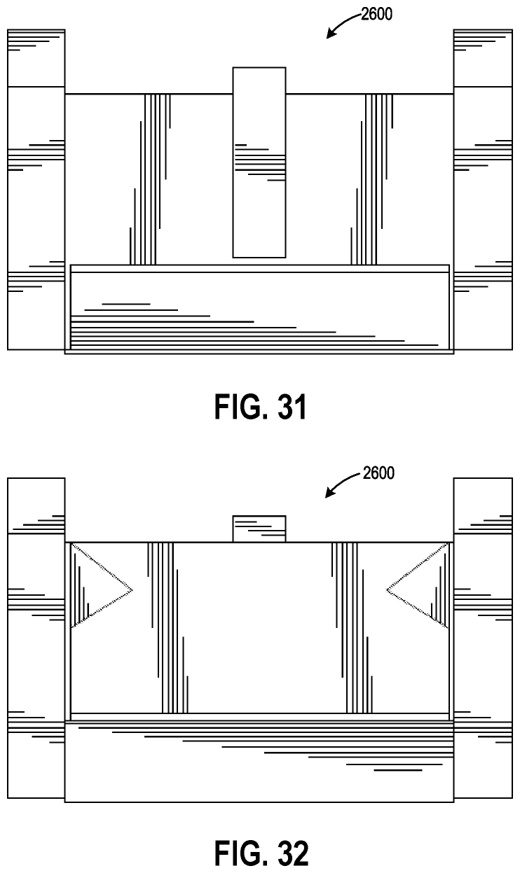

FIGS. 26-32 together illustrate a fourth component 2600 suitable for use with the disclosed tractor bucket adapter. In the example, the component is a sod removal tool. In the example, the sod removal tool 2600 may be used to temporarily or permanently remove sod from a lawn to install a pond or pool, for example. Alternatively, or in addition thereto, the sod removal tool may be used to remove sod that can be rolled up to allow temporary access to the ground below the sod and, once the user has finished performing whatever task need be done to the ground, the sod can be simply unrolled and replaced on the ground. FIG. 27 is a back perspective view of the fourth component 2600. FIG. 28 shows a side elevation view of the component 2600, and FIGS. 31 and 32 show a top side and a bottom side elevation view of the component 2600. FIGS. 29 and 30 show a front and a back plan view of the component 2600.

In contrast to the digging tool components described with reference to FIGS. 8-25, each having substantially planar or flat working surfaces for digging applications, the sod removal tool 2600, as particularly illustrated in FIG. 26, may comprise two upright sides 2602, 2604 connected by an upper horizontal section 2606. A coupling portion 2608 may be provided at the upper section 2606 for facilitating removable attachment of the sod removal tool 2600 to an intermediary component, as previously described. The sod removal tool 2600 may further comprise a lifting section 2610 connected to and extending between the two upright sides 2602, 2604. Further, referring to FIG. 28, the lifting section 2610 may be oriented at an angle 2612 relative to a horizontal plane 2614, such as 135 degrees, for instance, or another suitable angle. The lifting section 2610 and/or the upright sides 2602, 2604 may be formed as a blade, having sharpened forward and/or rearward edges. In this way, in conjunction with the angled lifting section 2610, the sod removal tool 2600 may be configured for separating (e.g., cutting) a strip of sod for removal from a lawn, such that the strip of sod can be temporarily or permanently removed in an effective and inexpensive manner.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated.

Consequently, in view of the wide variety of permutations to the embodiments that are described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

FIGS. 1-33 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. The subject matter of the present disclosure includes all novel and non-obvious combinations and sub-combinations of the various systems and configurations, and other features, functions, and/or properties disclosed herein.

As used herein, the terms “substantially” and “approximately” are construed to mean plus or minus five percent of the range, unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a tractor bucket adapter configured to be removably attached to a bucket of a tractor; and
at least one component configured to be removably attached to the tractor bucket adapter.

2. The system of claim 1, wherein the at least one component includes a digging tool configured to dig a trench.

3. The system of claim 1, wherein the digging tool has a generally rectangular geometry and has a width of approximately 4 inches.

4. The system of claim 1, wherein the digging tool has a generally rectangular geometry and has a width of approximately 8 inches.

5. The system of claim 1, wherein the digging tool has a generally rectangular geometry and has a width of approximately 12 inches.

6. The system of claim 1, wherein the at least one component includes a sod removal tool configured to remove sod from a lawn.

7. The system of claim 1, wherein the tractor bucket adapter is made of steel.

8. The system of claim 1, further comprising an intermediary component configured to facilitate the removable attachment between the tractor bucket adapter and the at least one component.

9. The system of claim 8, wherein the intermediary component includes three portions that each have a length.
